(19) United States
(12) Patent Application Publication
(10) Pub. No.: US 2022/0019650 A1
(43) Pub. Date: Jan. 20, 2022

(54) AUTHENTICATION DEVICE, AUTEHNTICATION METHOD, AND PROGRAM

(71) Applicant: Showcase Inc., Tokyo (JP)

(72) Inventors: Shigeharu TAKANO, Tokyo (JP); Narayan KHADKA, Tokyo (JP); Takuya MOTOSHIMA, Tokyo (JP)

(73) Assignee: Showcase Inc., Tokyo (JP)

(21) Appl. No.: 17/294,253

(22) PCT Filed: Nov. 30, 2018
(86) PCT No.: PCT/JP2018/044252

§ 371 Date: May 14, 2021

(51) Int. Cl. G06F 21/32

(52) U.S. Cl. CPC G06F 21/32

(57) ABSTRACT

An authentication device, an authentication method, and program, that effectively prevent unauthorized access without compromising the convenience of face authentication, are provided.

The authentication device 100 includes a first authentication means 110 for performing an authentication of a user based on a face image photographed, and a second authentication means 120 for requesting the user to perform a predetermined motion, for photographing the user performing the predetermined motion, and for authenticating the user based on a motion image photographed, when the authentication in the first authentication means is successful.

### TECHNICAL FIELD

The present invention relates to an authentication device, an authentication method, and program that perform authentication based on a face image of a user.

### BACKGROUND ART

A face authentication device, such as in Patent Document 1, is known as an authentication device which photographs a face of a user to get a face image by a photographing device such as a camera, compares the face image with a record image previously recorded or a moving image or the like, and performs authentication.

Face authentication is useful as a convenient and secure authentication method because it enables the authentication based on the biometric characteristics of the user and eliminates the need for keys and passwords.

### PRIOR ART DOCUMENT

### Patent Document

Patent Document 1: Japanese Patent Application Laid-Open No. 2008-146539

### SUMMARY OF INVENTION

### Problems to be Solved by the Invention

As described above, face authentication is a convenient authentication method because there is no need for a key or a password. However, a conventional face authentication device has the problem of allowing unauthorized access by holding a photograph of a face of a user in front of the camera.

The present invention has been made in view of the above problems and provides an authentication device, an authentication method, and program that effectively prevent unauthorized access without compromising the convenience of face authentication.

### Means for Solving Problems

In order to solve this problem, the invention of claim 1 is an authentication device used by a user for personal authentication, comprising:

a first authentication means for photographing a face of the user by operating a photographing device and for performing an authentication of the user based on a face image photographed by the photographing device; and

a second authentication means for requesting the user to perform a predetermined motion, for photographing the user performing the predetermined motion by operating the photographing device, and for authenticating the user based on a motion image photographed by the photographing device, when the authentication in the first authentication means is successful.

The invention of claim 2, in the authentication device according to claim 1, comprising:

a communication means for communicating with a Web browser provided in a user terminal used by the user, the photographing device being provided in the user terminal; and

a photographing device operating means for operating the photographing device by transmitting to the Web browser an HTML code including an instruction for operating the photographing device through a communication using the communication means.

The invention of claim 3, in one of claim 1 or claim 2, further comprising:

a recording means for recording a record image of the face of the user previously photographed,

wherein the first authentication means performs the authentication by comparing the face image of the face of the user with the record image recorded in the recording means.

The invention of claim 4 is an authentication method performed by an authentication device used by a user for personal authentication, comprising:

a first authentication step for photographing a face of the user by operating a photographing device and for performing an authentication of the user based on a face image photographed by the photographing device; and

a second authentication step for requesting the user to perform a predetermined motion, for photographing the user performing the predetermined motion by operating the photographing device, and for authenticating the user based on a motion image photographed by the photographing device, when the authentication in the first authentication step is successful.

The invention of claim 5 is a computer-readable program, wherein a computer functions as an authentication device as claimed in any of claims 1 to 3.

### Effect of Invention

According to the configuration of the present invention, after the authentication of the user based on the face image photographed for the face of the user in the first authentication means has been successful, the user performing the predetermined motion is photographed as the motion image and the authentication is performed based on the motion image in the second authentication means. Since both the first authentication means and the second authentication means authenticate the user based on images photographing the user, unauthorized access can be effectively prevented without compromising the convenience of face authentication.

### BRIEF DESCRIPTION OF THE DRAWINGS

FIG. 1 is a block diagram conceptually illustrating the entire configuration of the authentication device according to an embodiment.

FIG. 2 is a flow diagram conceptually illustrating a flow of authentication processing according to the embodiment.

FIG. 3 is a diagram conceptually illustrating a screen configuration when authentication is performed by the first authentication means in the embodiment.

FIG. 4 is a diagram conceptually illustrating a screen configuration when authentication is performed by a second authentication means in the embodiment.

### EMBODIMENT FOR CARRYING OUT THE INVENTION

Hereinafter, embodiments of the present invention will be described with reference to the drawings.

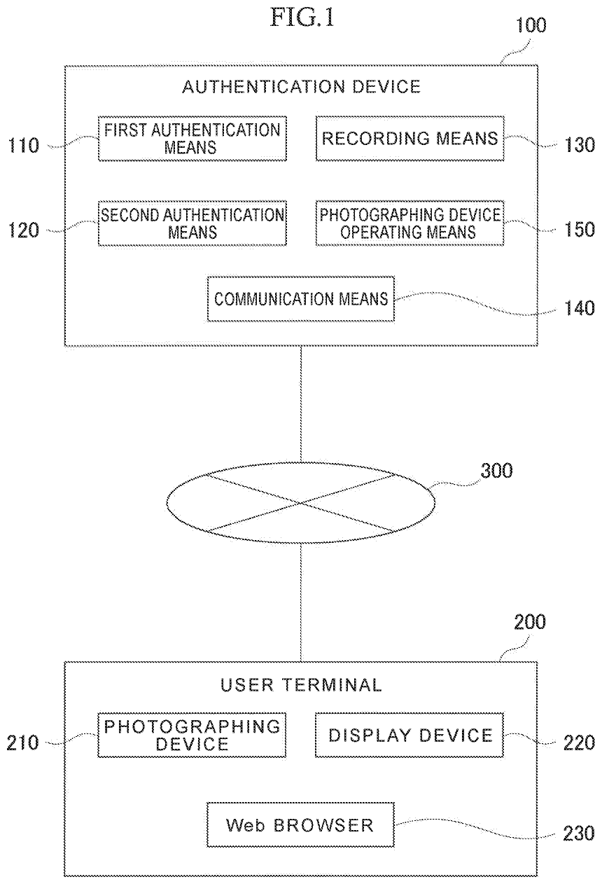

FIG. 1 is a block diagram conceptually illustrating the configuration of the entire authentication device 100 according to an embodiment of the present invention. The authentication device 100 according to the present embodiment provides a function for authenticating the user using the user terminal 200.

As shown in FIG. 1, the authentication device 100 includes a first authentication means 110, a second authentication means 120, a recording means 130, a communication means 140, and a photographing device operating means 150.

In this embodiment, the authentication device 100 is communicatively connected to the user terminal 200 described below via the network 300 described below. The authentication device 100 and the user terminal 200 are configured to communicate using the Hyper Text Transfer Protocol (HTTP) to provide the authentication function to the user as a so-called Web application where the authentication device 100 is a server and the user terminal 200 is a client. Although the configuration of this embodiment is as above, the entire of the authentication process may be configured to be performed only by the authentication device 100. Also, a well-known protocol for using in communication between the authentication device 100 and the user terminal 200 may be selected. If HTTP is used in the protocol, Hyper Text Transfer Protocol Secure (HTTPS) or the like may be used to exchange with HTTP on encrypted communications.

In this embodiment, the authentication device 100 is configured by using a well-known server computer. In this embodiment, a program for executing the authentication method described below is stored in advance in the secondary storage device of the computer, and the program is loaded into a memory and executed by the CPU, thereby causing the computer to function as the authentication device 100.

As described above, in this embodiment, the authentication device 100 is configured by using a computer used for a server, but the computer used in the authentication device 100 can be selected appropriately. For example, a typical personal computer may be used as the authentication device 100, or a portable terminal, such as a tablet computer, may be used to configure the authentication device 100. The hardware configuration of the authentication device 100 may be changed arbitrarily depending on the performance, durability and reliability, etc. required in the authentication device 100.

The first authentication means 110 photographs the face of the user by operating the photographing device 210 of the user terminal 200 used by the user with the photographing device operating means 150 described below, and the user is authenticated based on a face image photographed by the photograph device 210. Here, it is arbitrarily selectable whether a still image or a movie image is used as the face image.

When the authentication by the first authentication means 110 as described above is successful, the second authentication means 120 requests the user to perform a predetermined motion, operates the photographing device 210 by a photographing device operating means 150 described below to photograph the user performing the predetermined motion, and performs an authentication of the user based on a motion image photographed. Similar to the first authentication means 120 described above, it is arbitrarily selectable whether the motion image handled by the second authentication means 110 is a still image or a moving image.

The recording means 130 records the record image which is compared with the face image photographed by the photographing device 210 described later at the time of the authentication process performed by the first authentication means 110.

In this embodiment, the recording means 130 is configured with a portion of the secondary storage device provided by the authentication device 100. However, the configuration of the recording means 130 can be changed appropriately, and the recording means 130 may be constructed by using, for example, a relational database management system (RDBMS).

The communication means 140 communicates with the user terminal 200 via a network 300 described below. The present embodiment is configured as a Web application as described above, and the communication means 140 communicates with the Web browser 230 of the user terminal 200 by HTTP.

The photographing device operating means 150 operates the photographing device 210 described below to photograph the user. This embodiment is constructed as a Web application as described above, and the Hyper Text Markup Language (HTML) code including instructions for operating the photographing device 210 at the authentication is transmitted to the user terminal 200 to operate the photographing device 210. It should be noted that the above instructions may be described directly in the HTML code to be sent or may be described to refer to a program such as a script containing the above instructions from the HTML code.

The user terminal 200 is a terminal used by the user who performs the authentication processing. As described above, the present embodiment performs the authentication processing by a Web application, and the user terminal 200 functions as a client in the Web application. The user terminal 200 includes the photographing device 210, a display device 220, and a Web browser 230.

In this embodiment, the user terminal 200 is configured by using a portable terminal such as a smartphone. When the Web browser 230 of the user terminal 200 accesses a predetermined address of the authentication device 100, the authentication process described below is started. The user terminal 200 according to the present embodiment may use a computer known in the art, such as a general personal computer, if the computer includes the photographing device 210, the display device 220, and the Web browser 230.

The photographing device 210 is a camera for photographing the user. In this embodiment, a portable terminal, such as a smartphone, is used as the user terminal 200, and the camera provided in the portable terminal is used as the photographing device 210. When a typical personal computer or the like is used as the user terminal 200, a Web camera or the like connected to the personal computer or the like may be used as the photographing device 210.

The display device 220 is a display that displays the screen of the Web browser 230 described below. In this embodiment, a portable terminal, such as a smartphone, is used as the user terminal 200, and the touch panel display provided in the portable terminal is used as the display device 220.

The Web browser 230 communicates with the authentication device 100 via the network 300 described below and draws a predetermined screen on the display device 220 based on the HTML code transmitted from the authentication device 100. The network 300 is a network for communicatively connecting the authentication device 100 and the user terminal 200. The network 300 in this embodiment may be a wide area network, such as the Internet, or a local area network (LAN), if the communication is possible between the authentication device 100 and the protocol used by the user terminal 200. It may be a wired network, a wireless network, or a combined network of these.

The foregoing is the entire configuration of the authentication device 100 according to the present embodiment. The authentication processing in this embodiment will then be described.

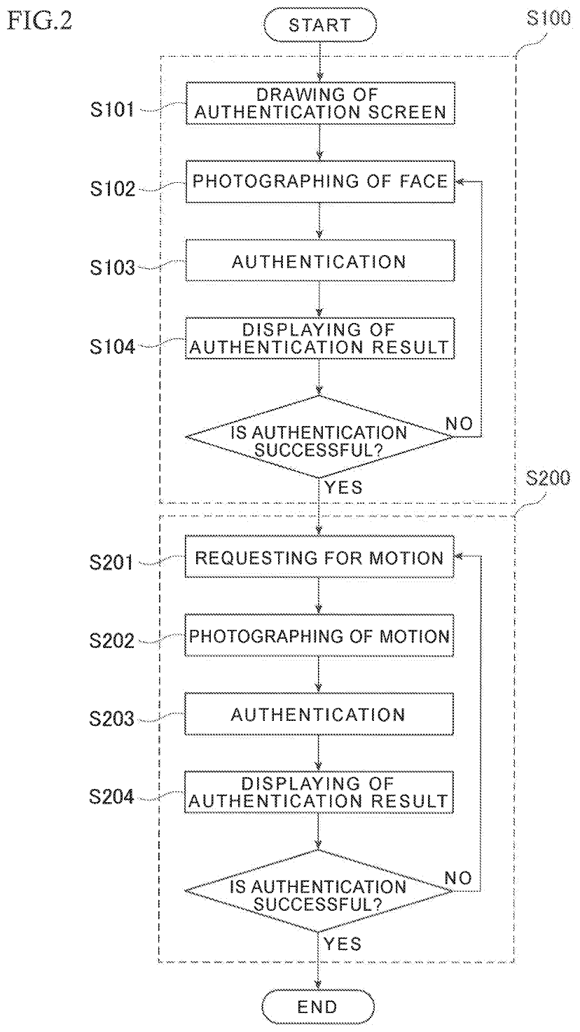

FIG. 2 is a flow diagram conceptually illustrating the flow of the authentication process by the authentication device 100 in this embodiment. In this embodiment, the user is authenticated by an authentication method consisting of the first authentication step S100 consisting of S101 to S104 and the second authentication step S200 consisting of S201 to S204.

The first authentication step S100 is the step for photographing the face of the user and performing an authentication of the user based on a face image photographed.

When the Web browser 230 of the user terminal 200 accesses the authentication device 100, the authentication device 100 transmits to the user terminal 200 the HTML code constituting the authentication screen as an HTTP response message. The Web browser 230 of the user terminal 200 draws the authentication screen on the display device 220 based on the HTML code (see S101).

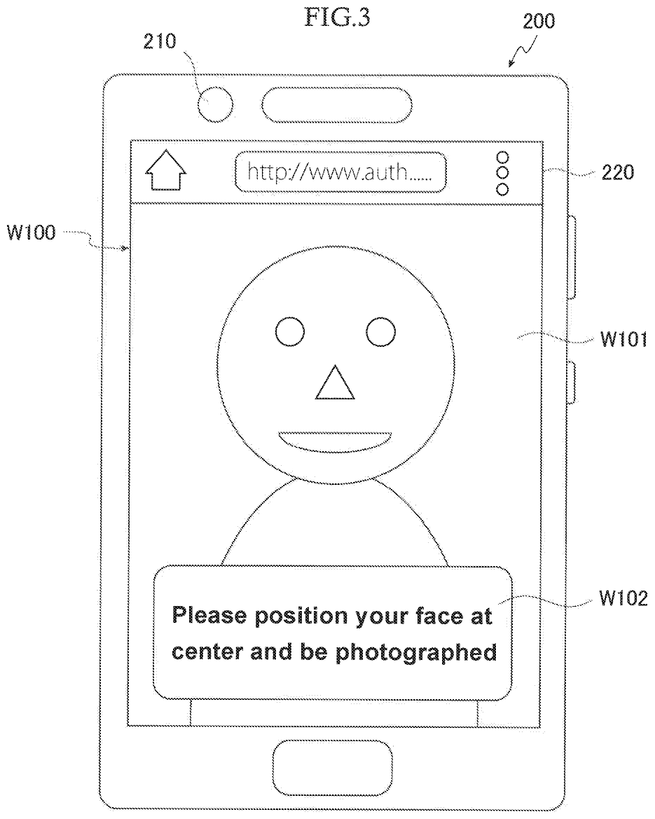

FIG. 3 is a diagram schematically illustrating the screen configuration of the authentication screen W100 according to the present embodiment. As shown in FIG. 3, the display device 220 of the user terminal 200 has a full-screen display of the authentication screen W100 drawn by the Web browser 230, and the authentication screen W100 includes a video area W101 for displaying the face image photographed by the photographing device 210 and a message area W102 for displaying messages transmitted from the authentication device 100 to the user.

In step S101 described above, the HTML code transmitted from the authentication device 100 includes a text information indicating that a face is to be photographed (for example, data for displaying a statement for indicating to the Web browser 230 that a face is to be photographed or data for displaying an image), and instructions for operating the photographing device 210 of the user terminal 200. The Web browser 230 of the user terminal 200 displays the statement in the message area W102. In FIG. 3, text information that “Please position your face at center and be photographed” is displayed in the message area W102. The photographing device operation means 150 operates the photographing device 210 based on the above-described instructions and the face of the user is photographed (see S102). FIG. 3 illustrates a situation in which the face is positioned at the center of the screen (i.e., the Web browser 230) and is photographed, which is an action that the user using the user terminal 200 is requested in step S101.

In this embodiment, the recording means 130 of the authentication device 100 records a record image of the face of the user previously photographed. The first authentication means 110 of the authentication device 100 performs the authentication of the user by comparing the face image photographed in step S102 as described above with the record image recorded previously in the recording means 130 (see S103). The specific method for comparison may be implemented by using a well-known method. For example, a method of detecting a feature (for example, information about characteristic points) of the user may be detected from the face image photographing the face of the user and an authentication can be performed based on the detected feature. (For example, information about characteristic points detected from the face image photographed by the photographing device 210 and information about characteristic points detected from the record image recorded in the recording device 130 are used, and it is determined whether the user of the user terminal 200 who is photographed by the photographing device 210 is the same as the person recorded in the recording means 130 based on the differential data between information about characteristic points detected from the face image and information about characteristic points detected from the record image. Other method for comparison may be used.

The text indicating the result of step S103 described above, that is, whether or not the authentication by the first authentication step was successful is transmitted by the authentication device 100 to the user terminal 200, and the Web browser 230 of the user terminal 200 receives the text and displays it in the message area W102 of the authentication screen W100 (see S104).

In this embodiment, if the authentication by the first authentication step S100 fails, the processing can be executed again from step S102 to perform the authentication process again. Whether or not the authentication can be re-executed when authentication fails and the number of times the authentication can be re-executed, etc. may be optionally selected.

When the authentication is successful by the first authentication step S100, the authentication device 100 starts the second authentication step S200.

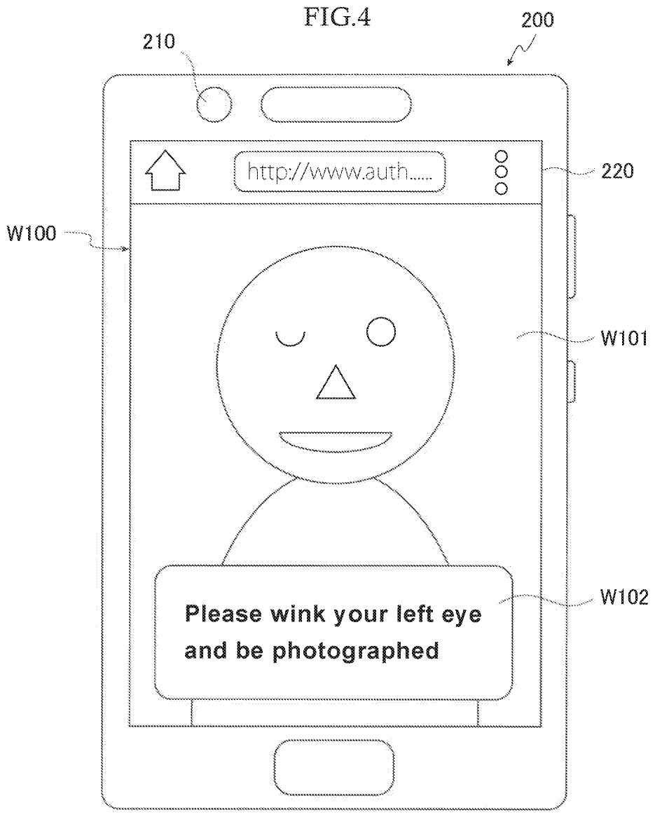

When the second authentication step S200 is started, the authentication device 100 transmits to the user terminal 200 a text information requesting the user to perform a predetermined motion (for example, data for displaying a statement requesting to the Web browser 230 or data for displaying an image, etc.). The text information is displayed in the message area W102 of the authentication screen W100 by the Web browser 230 of the user terminal 200 (S201). The predetermined motion may optionally be selected, for example, a wink motion in which a user closes one eye, or a motion to take a peace sign or other pauses. In FIG. 4, the text information indicating “Please wink the left eye and be photographed” is displayed in the message area W102.

When the predetermined motion requested in step S201 is performed by the user, the photographing device operating means 150 operates the photographing device 210 of the user terminal 200 and the user who performs the requested motion is photographed (see S202). FIG. 4 illustrates a motion image in which the left eye is winked (and the motion image is displayed in a state of left and right reversed on the Web browser 230), and FIG. 4 illustrates the motion requested to the user using the user terminal 200 in step S201.

FIG. 4 is a diagram schematically illustrating the configuration of the authentication screen W100 when the user performing the motion is photographed by the photographing device 210 in step S201 and step S202 described above. As shown in FIG. 2, the text requesting the predetermined motion, which is transmitted from the authentication device 100, is displayed in the message area W102, and when the user performs the motion in accordance with the request, the user performing the motion is photographed by the photographing device 210 of the user terminal 200.

In this embodiment, the second authentication means 120 performs a process of checking the motion image photographed, and authenticates whether or not the user using the user terminal 200 performs a predetermined process (see S203).

Specifically, the specific method of comparison in step S203 is, for example, a method in which the information about the characteristic points which is detected from the face image photographed in step 102 by the photographing device 210 and the information about the characteristic points which is detected from the motion image photographed in step 202 by the photographing device 210 are used, and whether or not the user of the user terminal 200 performed the predetermined motion requested is determined based on the differential date between these information about the characteristic points of the face image and the motion image. By using such procedures, it can be confirmed that the user using the user terminal 200 is actually operating the user terminal 200 in real time.

Therefore, for example, even if a malicious third party, by photographing a facial photography of the user by using the photographing device 210 in the user terminal 200, would illegally login and would successfully authenticate in the first authentication step S100, the second authentication step S200 results in being failed. Then, it can be prevented that such a malicious third party could succeed to result in an unauthorized login by performing unauthorized authentication operations such as using a user's facial photograph, etc.

Further, in the procedure of step S203, it may be possible to determine whether a predetermined motion has been performed by the user using the user terminal 200 by using any method other than the above. For example, the face of the user after the predetermined motion of the user is also photographed and is recorded in the recording means 130, and the record image in step S202 is compared with the facial photograph photographed after the predetermined motion of the user to authenticate.

When the authentication by the second authentication means 120 is completed in step S203, the authentication device 100 transmits a statement indicating its success or failure to the user terminal 200 (S204). If the authentication is successful, the authentication process in this embodiment is completed. If the authentication fails, then the second authentication step S200 is started again from step S201. In addition, whether or not the second authentication step S200 is executed again, and the number of times the second authentication step S200 is executed again, etc. may be set arbitrarily in the same manner as the step S104 described above. In addition, when the authentication fails in step S200, it may be performed again from step S100.

The foregoing is a flow of authentication processing according to the present embodiment. In this embodiment, after the authentication based on the face image photographing the face of the user in the first authentication step S100 is successfully performed, the motion of the user is photographed in the second authentication step S200 and the authentication based on the motion image photographed is performed. Since both the first authentication step S100 and the second authentication step S200 perform the authentications based on the face image and the motion image in which the user is photographed, an unauthorized access can be effectively prevented without compromising the convenience of facial authentication.

The present embodiment includes the communication means 140 for communicating with the Web browser 230 provided in the user terminal 200 equipped with the photographing device 210, and the photographing device operating means 150 for operating the photographing device 210 by transmitting an HTML code including an instruction for operating the photographing device 210 to the Web browser 230 through communication using the communication means 140. Then, in spite of that the authentication device 100 and the user terminal 200 are physically separated, the operation for authentication is performed by the user from the Web browser 230 of the user terminal 200 and authentication can be easily and reliably performed based on the face image photographed by the user.

In this embodiment, the authentication device 100 further includes the recording means 130 for recording the record image which is the image of the face of the user photographed previously, and the first authentication means 110 compares the face image, which is the image of the face of the user photographed, with the record image recorded in the recording means 130 and the first authentication means 110 performs the authentication. Thus, since it can be determined whether both the face image and the record image are close to each other and the authentication is success or failure by contrasting the face image photographed with the record image recorded, the high-precision authentication can be performed.

Although the present embodiment is described above, the configuration of the present invention is not limited to the above-described embodiment. For example, in the present embodiment, the second authentication step S200 is configured to restart from step S201 only when the authentication by the second authentication step S200 fails. However, the second authentication step S200 may be executed a plurality of times

Further, for example, in the above-described embodiment, the authentication device 100 is configured to be connected by the network 300 to the user terminal 200 located at a different location, but the authentication device 100 may be configured to be incorporated into the user terminal 200.

For example, although the present invention has been used in the embodiment described above to authenticate the user using the user terminal 200, the authentication device 100 of the present invention may be applied to a configuration other than the user terminal 200, for example, a configuration that performs a facial authentication for the entrants entering a particular room or a space (for example, an event venue, a stadium, a railway station premise, etc.). In addition, the authentication device 100 of the present invention may be applied to a communication device other than the user terminal 200, or a login or user authentication of an electrical device. In this case, as in the embodiment described above, the authentication device 100 may be configured to be connected by the network 300 and to be set in a place different from the place where entrants enter, or the authentication device 100 may be configured to be set in a place where the entrants enter.

Other specific configurations are not limited to the present embodiment, and various modifications may be made to the extent that they do not deviate from the scope of the present invention.

### EXPLANATION OF REFERENCE

100 authentication device
110 first authentication means
120 second authentication means
130 recording means
140 communication means
150 photographing device operating means
200 user terminal
210 photographing device
220 display device
230 Web browser
300 network

1. An authentication device used by a user for personal authentication, comprising:
a first authentication means for photographing a face of the user by operating a photographing device and for performing an authentication of the user based on a face image photographed by the photographing device; and
a second authentication means for requesting the user to perform a predetermined motion, for photographing the user performing the predetermined motion by operating the photographing device, and for authenticating the user based on a motion image photographed by the photographing device, when the authentication in the first authentication means is successful.

2. The authentication device according to claim 1, comprising:
a communication means for communicating with a Web browser provided in a user terminal used by the user, the photographing device being provided in the user terminal; and
a photographing device operating means for operating the photographing device by transmitting to the Web browser an HTML code including an instruction for operating the photographing device through a communication using the communication means.

3. The authentication device according to claim 1, further comprising:
a recording means for recording a record image of the face of the user previously photographed,
wherein the first authentication means performs the authentication by comparing the face image of the face of the user with the record image recorded in the recording means.

4. An authentication method performed by an authentication device used by a user for personal authentication, comprising:
a first authentication step for photographing a face of the user by operating a photographing device and for performing an authentication of the user based on a face image photographed by the photographing device; and
a second authentication step for requesting the user to perform a predetermined motion, for photographing the user performing the predetermined motion by operating the photographing device, and for authenticating the user based on a motion image photographed by the photographing device, when the authentication in the first authentication step is successful.

5. A computer-readable program which makes a computer to function as an authentication device of claim 1.

6. The authentication device according to claim 1, wherein the predetermined motion is a wink motion in which the user closes one eye.

7. The authentication device according to claim 1, wherein the predetermined motion is a motion to take a peace.

8. The authentication device according to claim 1, wherein the second authentication means authenticates the user based on a differential date between information about characteristic points detected from the face image and information about characteristic points detected from the motion image.

9. The authentication device according to claim 2, wherein the authentication device plays as a server and the user terminal plays as a client.

10. The authentication method according to claim 4, wherein the predetermined motion is a wink motion in which the user closes one eye.

11. The authentication method according to claim 4, wherein the predetermined motion is a motion to take a peace.

12. The authentication method according to claim 4, wherein the second authentication step authenticates the user based on
a differential date between information about characteristic points detected from the face image and information about characteristic points detected from the motion image.

13. The authentication method according to claim 4, wherein the authentication device plays as a server and a user terminal plays as a client.
